(19) United States
(12) Patent Application Publication
(10) Pub. No.: US 2009/0124784 A1
(43) Pub. Date: May 14, 2009

(54) Methods and compounds for curing polythiourethane compositions

(76) Inventors: Chad W. Brown, Bartlesville, OK (US); Mitchell D. Refvik, Bartlesville, OK (US); Jim D. Byers, Bartlesville, OK (US); Roger A. Patton, Bartlesville, OK (US); Adrian Pullen, Boston, MA (US); John F. Martin, Wilmington, MA (US)

Correspondence Address: FLETCHER YODER (CHEVRON PHILLIPS), P. O. BOX 692289, HOUSTON, TX, 77069, US

(21) Appl. No.: 11/983,387

(22) Filed: Nov. 8, 2007

(51) Int. Cl. C08G 18/18

(52) U.S. Cl. 528/49

(57) ABSTRACT

The present techniques relate to formulations that include a first part containing active molecules that have an average of at least one thiol group per active molecule and an average of at least one hydroxyl group per active molecule, and a second part containing monomer molecules that have an average of at least two isocyanate groups per monomer molecule. The composition may be mixed with a catalyst composition that contains at least one amine catalyst and at least one metal catalyst. This mixed catalyst composition will substantially cure a mixture of the first part and the second part within less than about 48 hours at ambient temperature.

### BACKGROUND OF THE INVENTION

The present techniques generally relate to thiourethane compositions made from reactions of compositions containing compounds having thiol and hydroxyl groups with compositions containing compounds having isocyanate groups. The techniques are suitable for decreasing the time needed to cure polythiourethane compositions or increasing the rate at which polythiourethane composition cure. The present techniques also provide specific methods for curing compositions at ambient temperatures.

This section is intended to introduce the reader to aspects of art that may be related to aspects of the present techniques, which are described and/or claimed below. This discussion is believed to be helpful in providing the reader with background information to facilitate a better understanding of the various aspects of the present techniques. Accordingly, it should be understood that these statements are to be read in this light, and not as admissions of prior art.

As chemical and petrochemical technologies have advanced, the products of these technologies have become increasingly prevalent in society. In particular, as techniques for bonding simple molecular building blocks into longer chains, termed polymers, have advanced, the polymer products, typically in the form of various plastics, have been increasingly incorporated into various everyday items. For example, polyurethane polymers and copolymers, made from the reactions of compounds containing hydroxyl groups with compounds containing isocyanate groups, may be used in retail and pharmaceutical packaging, furniture, household items, automobile components, adhesives, coatings, and various other consumer and industrial products.

The chemical industry strives to make these products with low-cost feedstocks that are in abundant supply. Currently, the main feedstocks for polyurethanes, and other plastics, are petrochemicals isolated from petroleum. However, as fossil fuels deplete over time, alternative sources are being sought as replacements for feedstocks. Further, the chemical industry continuously strives to produce products and use feedstocks that are environmentally friendly in order to reduce potential hazards and risks related to safety and environmental issues.

### DETAILED DESCRIPTION OF SPECIFIC EMBODIMENTS

One or more specific embodiments of the present techniques will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

One potential source of alternative feedstocks for polymers is natural source oils, for example, oils isolated from soybeans, corn, or other vegetable or animal sources. These oils may provide a renewable source of raw materials for the production of numerous materials currently made from fossil fuels. Accordingly, research has focused on effectively utilizing these natural feedstocks in various polymers.

For example, natural source oils include unsaturated esters that may be reacted with different chemical compounds to form reactive groups that may be used in further reactions. For example, unsaturated esters may be reacted with hydrogen sulfide to form thiol groups along the carbon chains. In another example, the unsaturated esters may be initially reacted with oxygen containing groups to form epoxy groups. These epoxidized oils may then be reacted with hydrogen sulfide to form molecules having both thiol groups and hydroxyl groups along the carbon chain. Such reactions are not limited to natural source oils, as any number of carbon compounds containing one or more carbon-carbon double bonds may be used to form these molecules. The compounds containing thiol groups and urethane groups may then be reacted with isocyanate groups to form compositions containing thiourethane and/or urethane groups.

### Overview

The present techniques are directed to thiourethane compositions that include the contact products of reactive compositions containing active molecules having hydroxyl and thiol groups with monomer compositions containing monomer molecules having isocyanate groups. The thiourethane compositions formed as the contact product may include the contacted compounds, reaction products formed from the contacted compounds, or both, in addition to other ingredients, as discussed below. These thiourethane compositions may be useful in coatings or adhesives, as well as in other types of commercial and industrial products. The reactions may be initiated by water, for example, in moisture cured adhesives, or may be performed using amine or metal catalysts. However, to achieve a substantially complete reaction of the active hydrogen groups with the isocyanate groups, termed cure, either a high temperature treatment or a long cure time may often be necessary.

In contrast, the present techniques include mixed catalyst compositions that contain both amine catalysts and metal catalysts, which may allow for curing at lower times and/or temperatures than considered feasible with equivalent concentrations of either single catalyst system by itself. This unexpected synergistic effect may provide methods for forming adhesive and coating compositions, among other compositions and items, that do not require oven curing, may be used under field conditions, or provide for a decreased cure time.

Compositions that Cure at Low Times and Temperatures

Embodiments of the present techniques include formulations for coatings or adhesives made from the reaction products of reactive compositions that contain active molecules having thiol and hydroxyl groups, among others, with monomer compositions that contain monomer molecules having isocyanate groups. The reactions are performed using catalyst compositions that contain both amine catalysts and metal catalysts. These mixed catalyst compositions have been found to enable the curing reaction to progress at faster rate, at a particular temperature, than is possible with an equivalent concentration of either type of catalyst by itself. Further, the mixed catalyst compositions may allow advantageously for a substantially complete cure at ambient temperature and applications may include adhesives, coatings, and other products. Beneficially, the ambient temperature cure may provide for curing without the application of an external heat source.

The use of the term “ambient temperature” indicates that the adhesives or coatings were not subjected to additional heating outside of the current temperature at the location of use. Specifically, the adhesives or coatings were not subjected to a baking process purposefully intended to accelerate the curing reaction. However, depending on the actual environment of use, the temperature may still be quite high, although not at levels typically used in baking processes.

For example, the temperature of outdoor environments in which the adhesives or coatings may be used could range from 5° C. to 60° C. The low end of this range may represent a situation in which the surface being treated may be the surface of a deck or fence being coated on a clear day in the winter. The high end of the outdoor temperature range, 60° C., may be reached on a metal surface during a summer day. Furthermore, while indoor environments may have a somewhat narrower temperature range, depending on the purpose of the environment, they may still have significant extremes. For example, a computer room may be kept to around 10° C. to keep the equipment from overheating. In contrast, a warehouse, or attic, may not be air-conditioned and, thus, may reach temperatures of 50° C., or even higher, during summer months.

Accordingly, ambient temperature for purposes of the curing reactions discussed herein may be generally about 5° C. to 60° C., depending on location. While curing may occur at even faster rates if the temperature is above 60° C., such temperatures are rarely reached without the addition of heat, such as in a baking process, and, therefore, are generally not considered to be an ambient temperature. Within the range of ambient temperature, the rate of cure depends on the temperature, with a faster cure typically being achieved as the temperature increases.

Generally, the determination whether the catalyst composition that includes an amine catalyst and a metal catalyst provides a faster cure, e.g. a substantially complete cure, is made by comparing the cure time of catalyst composition to the cure time of the amine catalyst or the metal catalyst alone under essentially the same conditions. Generally, the determination whether the catalyst composition that includes an amine catalyst and a metal catalyst enables the formulation to cure at a lower temperature, e.g. a substantially complete cure, is made by determining whether the formulation can cure the composition or formulation at a lower temperature, in a equivalent time period (or less) than that of the amine catalyst or the metal catalyst alone.

The use of the term “substantially complete cure” indicates that the formulation has achieved a substantial percentage of the total possible intermolecular and intramolecular bonding that may occur in the composition. The total possible bonding that may take place does not necessarily correspond to a 100% reaction of all reactive chemical groups. Many reactive groups may be left unreacted in a coating or adhesive formulation due to the increased viscosity of the formulation as it cures. The increased viscosity may hinder mobility of the reactive groups and, thus, trapping the reactive groups and preventing complete reaction. For example, in a formulation that has achieved maximum strength, it is possible that only 80%, or even less, of all possible chemical reactions may have actually occurred.

Accordingly, the best determination of the proportion of curing in a formulation may be by physical measurements that determine when the material has ceased to increase in strength, such as hardness, impact strength, or adhesive strength, among others. For example, as a sample is cured, hardness measurements taken at different time periods may indicate that the hardness is continuing to increase, indicating that bonding reactions are continuing. Comparisons between different formulations, or even repeating runs of the same formulation, may yield somewhat different end points for strength and hardness, as statistical variations in the active molecules have created slightly different numbers of bonds that may be formed. However, the time to reach a substantially complete cure is likely to be the same for the same formulations, and the maximum strength or hardness of the samples should be similar.

A particular measure that may be utilized to determine whether the catalyst composition will cure an mixture at lower times and/or temperatures include a determination whether the mixture cures to obtain a particular property at a lower time and/or lower temperature than with the amine catalyst or the metal catalyst alone. Some properties which may be utilized, either singly or in any combination, to make this determination include a Sward hardness, impact resistance, substrate adhesion, or tensile strength. These terms, taken together, may be generally classified as the strength of the mixture. Sometimes these determinations are made on the basis of whether the curing composition achieves 90% of the desired property at a lower time and/or temperature.

In some embodiments, the comparison is made at ambient temperature regardless of the temperature at with the composition is ultimately cured. For example, the measures could include whether the catalyst composition will cure a mixture of the first part and the second part to greater than about 50% of full strength at ambient temperature in less than about 48 hours, will cure a mixture to a strength after about 48 hours at ambient temperature that is within about 90% of a strength obtained if the mixture was baked at about 130° C. for about 3 hours, or will cure a mixture within about 48 hours at ambient temperature to a strength substantially equal to a strength of a similar mixture cured with only one of the amine or the metal catalyst after about 144 hours at ambient temperature, regardless of the actual curing temperature.

In various embodiments, the active molecules may have one or more thiol groups, one or more hydroxyl groups, or both thiol and hydroxyl groups. Generally, the active molecules in the reactive composition will average at least one thiol group per active molecule and at least one hydroxyl group per active molecule. For example, such active molecules may include mercaptanized unsaturated esters, mercaptanized epoxidized unsaturated esters, crosslinked mercaptanized unsaturated esters, thiol hydroxyl esters or any combination thereof.

As discussed in detail in the following sections, these active molecules may be made from natural source oils, including, for example, soybean oil, castor oil, corn oil, canola oil, and other types of natural oils. Further, the active molecules may be made from synthetic molecules, such as synthetic esters produced by the reaction of molecules having hydroxyl groups with molecules having both carboxylic acid groups and carbon-carbon double bonds.

The monomer molecules may include aliphatic isocyanates, cyclic aliphatic isocyanates, aromatic isocyanates, or any combinations thereof. Generally, the isocyanate molecules in the monomer composition will average at least two isocyanate groups per monomer molecule. Specific isocyanate classes and compounds that may be used in embodiments are described in detail below.

Further, the compositions may include other ingredients such as property modifying agents or solvents, added before or after the reaction is completed. The property modifying agents may be used to strengthen the final products, give flexibility to the final products, or otherwise make the final products more useful or efficient, among other purposes. The solvents may be used to make the reactions proceed more efficiently by diluting the reaction products or may make the products lower viscosity to make application easier.

Compositions made using these processes may be useful for coatings or adhesives, among others. For example, an item may have at least part of a surface coated with the composition. This may be performed for various purposes, for example, to protect the surface or to protect graphics on the surface, among others. In other embodiments, two or more objects may be joined with an adhesive made from the compositions. It is believed that coatings made of the materials described herein may provide enhanced environmental protection or resistance, for example, to yellowing and water damage, than many coatings in current commercial use.

Specific components that may be used in embodiments of the present techniques are discussed in further detail in the sections that follow. Specifically, the first section discusses the formation of thiourethane and urethane groups, the next section details reactive compositions that contain active molecules having thiol and/or hydroxyl groups. The following section details monomer compositions that contain monomer molecules having isocyanate groups. The final section details solvents and other components that may be used in embodiments of the present techniques.

### Formation of Thiourethane and Urethane Groups

Isocyanate groups, —NCO, may react with any number of groups having active hydrogens to form bonds. For example, isocyanates will react with hydroxyl groups, thiol groups, amine groups, amide groups, or carboxylic acid groups, among others. The reaction of hydroxyl groups (—OH) with isocyanate groups, as shown in Equation 1, forms urethane groups that form the backbone of polyurethane polymers.

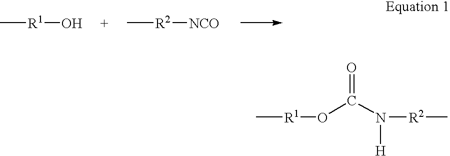

In this equation, R¹ and R² represent the chemical species to which the indicated reacting hydroxyl and isocyanate groups, respectively, are attached. R¹ may include aliphatic groups, aromatic groups, or any combination thereof, and may include other isocyanate reactive groups, such as additional hydroxyl groups and/or thiol groups, among others. R² may include aliphatic groups, aromatic groups, or any combination thereof, as well as other isocyanate groups. The isocyanate groups will also react with thiol, or —SH, groups to form thiourethane groups, as shown in Equation 2.

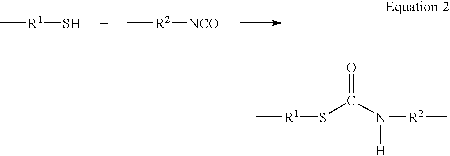

As in Equation 1, R¹ and R² represent the chemical species to which the indicated reacting thiol and isocyanate groups, respectively, are attached. R¹ may include aliphatic groups, aromatic groups, or any combination thereof, in addition to other isocyanate reactive groups, such as additional hydroxyl groups and/or thiol groups, among others. R² may include aliphatic groups, aromatic groups, or any combination thereof, in addition to other isocyanate groups.

The reactions above are generally performed in the presence of a catalyst composition. The catalyst compositions used to effect a faster cure under the conditions in which the thiourethane composition is formed, for example at ambient temperature, in embodiments of the present techniques generally include mixtures of amine catalysts and metal catalysts. Suitable amine catalyst may include a primary amine, a secondary amine, or a tertiary amine. In particular examples, the catalyst used to produce the polymer may include a tertiary amine. The amine, be it tertiary or other, may be an aliphatic or aromatic amine. Suitable amines may include a polyetheramine, a polyalkylene amine, or a tertiary amine polyol (e.g. Jeffol® A-480). Other suitable amine catalysts may include a polyamine comprising at least two amine groups. For example, the amine may be an amine derived from polypropylene glycol, a polyether amine, a polyalkylene amine or a tertiary amine polyol, or any combination thereof. The amine catalyst may also be a polyamine including at least two amine groups. In embodiments, the catalyst may be 1,8-diazabicyclo[5,4,0]undec-7-ene [DBU-CAS# 6674-22-2]; 1,4-diazabicyclo[2.2.2]octane [DABCO-CAS# 280-57-9]); or triethylamine. The metal catalyst used in the catalyst composition may be a tin catalyst, a bismuth catalyst, a zinc catalyst, an iron catalyst, or combinations thereof. Suitable metal catalysts include organometal catalyst, e.g. an organotin catalyst. In embodiments that include a tin catalyst, the tin compound may be dibutyl tin dilaurate.

Specific components that may be used in embodiments of the present techniques are discussed in further detail in the sections that follow. Specifically, the first section details reactive compositions that contain active molecules having thiol and/or hydroxyl groups. The following section details monomer compositions that contain monomer molecules having isocyanate groups. The final section details solvents and other components that may be used in embodiments.

Reactive Compositions that Include Thiol and Hydroxyl Groups

Reactive compositions that may be used in embodiments of the current techniques may include any combination of active molecules that contain hydroxyl and thiol groups. For example, the composition may include one or more active molecules having both hydroxyl and thiol groups. Alternatively, the composition may be made from a blend of active molecules having hydroxyl groups with active molecules having thiol groups. Generally, in embodiments, the composition will average at least one hydroxyl group and at least one thiol group per active molecule. For example, the composition may include a blend of active molecules having an average of two thiol groups per molecule with active molecules having an average of two hydroxyl groups per molecule. Further, the reactive composition may consist essentially of active molecules or may have other ingredients, including, for example, solvents, fillers, or other materials.

The reactive composition may include simple active molecules, such as, for example, 1-hydroxyl-2-mercaptocyclohexane, among others. These simple molecules may include aliphatic or aromatic molecules having 1-20 carbons, 0-5 hydroxyl groups, and 0-5 thiol groups, among others. In embodiments, the simple active molecules will average at least one hydroxyl group per active molecule and at least one thiol group per active molecule. This is not to imply that all molecules have both thiol groups and hydroxyl groups. Indeed, simple active molecules having an average of two hydroxyl groups per molecule may be combined with molecules having an average of two thiol groups per molecule. The simple molecules may also include aliphatic or aromatic molecules having 1-10 carbons, 0-3 hydroxyl groups, and 0-3 thiol groups. One of ordinary skill in the art will recognize that similar molecules will function in the present techniques and are well within the scope.

Instead of, or in addition to, the molecules discussed above, the reactive composition may contain more complex active molecules, potentially having several thiol and/or hydroxyl groups per active molecule, as well as other functional groups. These molecules may include, for example, the reaction products of hydrogen sulfide with unsaturated esters and/or the reaction product of hydrogen sulfide with epoxized unsaturated esters. Depending on the starting materials, these molecules may include mercaptanized unsaturated esters, mercaptanized epoxidized unsaturated esters, crosslinked mercaptanized unsaturated esters, or combinations thereof. The unsaturated esters used as the starting material for the active molecules listed above have at least one ester group and at least one carbon-carbon double bond within the unsaturated ester molecule and may be obtained from natural sources or synthetically formed. These molecules, and the unsaturated esters used as feedstocks in forming these molecules, are described in detail below.

“Natural sources” refers to materials obtained, by any method, from naturally occurring or genetically modified fruits, nuts, vegetables, plants, and animals. As an example, natural source oil refers to unsaturated esters extracted, and optionally purified, from naturally occurring or genetically modified fruits, nuts, vegetables, plants, and animals. Alternatively, the unsaturated esters may be produced using a combination of materials from natural and synthetic sources. For example, the unsaturated ester oil may be produced by the reaction of synthetic ethylene glycol and an oleic acid isolated from a natural source oil. Alternatively, the unsaturated ester oil may be produced from the reaction of glycerol isolated from natural source oils and a synthetic carboxylic acid, e.g. acrylic acid. Alternatively, the unsaturated ester oil may be produced from glycerol and oleic acid isolated from natural source oils.

The reactive composition used as a feedstock to produce the thiourethane compositions described herein may be described using a number of different methods, such as the type of functional groups present on the active molecules. For example, the reactive composition may contain active molecules having at least one ester group and at least one thiol group, referred to as a thiol ester. Alternatively, the active molecules in the reactive composition may include additional groups, such as hydroxyl groups, and/or polysulfide linkages —Sₓ— wherein x is an integer greater than 1. When the active molecules contain a hydroxy group, the thiol ester may be referred to as a hydroxy thiol ester. When the thiol ester has polysulfide linkages —Sₓ— wherein x is an integer greater than 1, the thiol ester may be referred to as a crosslinked thiol ester. When the thiol ester has a hydroxy group and a polysulfide group —Sₓ— wherein x is an integer greater than 1, the thiol ester may be referred to as crosslinked hydroxy thiol ester.

The active molecules in the reactive composition may also be described using a name that indicates the method by which they were formed. For example, an active molecule referred to as a mercaptanized unsaturated ester refers to a thiol ester produced by reacting hydrogen sulfide with an unsaturated ester. The mercaptanized unsaturated ester may be further described by the functional groups. For example, mercaptanized soybean oil may be further described by a combination of the number of ester groups and the number of thiol groups present in the mercaptanized soybean oil.

The active molecules that may be used in reactive compositions of the present techniques may be produced by reacting any unsaturated ester with hydrogen sulfide, as described in U.S. patent application Ser. Nos. 11/060,675; 11/060,696; 11/059,792; and 11/059,647 (hereinafter “the '675 applications”), each of which is incorporated herein by reference in its entirety. Because unsaturated esters may contain multiple carbon-carbon double bonds per unsaturated ester molecule, carbon-carbon double bond reactivity and statistical probability dictate that each mercaptanized unsaturated ester will not have the same number of thiol groups, number of cyclic sulfides, molar ratio of cyclic sulfides to thiol groups, and/or other quantities of functional groups and molar ratios disclosed herein as the unsaturated ester. Additionally, the unsaturated esters may also include a mixture of individual unsaturated esters having a different number of carbon-carbon double bonds and/or ester groups. Thus, many of these properties will be described as an average number of the groups per active molecule within the reactive composition.

Generally, the reactive compositions may be described as including the one or more separate or discreet functional groups of the active molecules. These independent functional groups can include: the number of (or average number of) ester groups per active molecule, the number of (or average number of) thiol groups per active molecule, the average thiol sulfur content of the reactive composition, the percentage (or average percentage) of sulfide linkages per active molecule, and the percentage (or average percentage) of cyclic sulfide groups per active molecule. Additionally, the reactive compositions may be described using individual or a combination of ratios including the ratio of double bonds to thiol groups, the ratio of cyclic sulfides to mercaptan groups, and the like. As separate elements, these functional groups of the thiol composition will be described separately.

The reactive composition may contain active molecules having an average of at least one ester group per active molecule. As the active molecules may be prepared from unsaturated esters, the active molecules may contain the same number of ester groups as the unsaturated esters from which they are prepared. In other examples, the active molecules may have an average of at least 1.5 ester groups per active molecule, an average of at least 2 ester groups per active molecule, an average of at least 2.5 ester groups per active molecule or an average of at least 3 ester groups per active molecule. Further, the thiol esters may have an average of from 1.5 to 8 ester groups per active molecule, an average of from 2 to 7 ester groups per active molecule, an average of from 2.5 to 5 ester groups per active molecule or an average of from 3 to 4 ester groups per active molecule.

The reactive composition may contain active molecules having an average of at least one thiol group per active molecule. In other examples, the active molecules may have an average of at least 1.5 thiol groups per active molecule, an average of at least 2 thiol groups per active molecule, an average of at least 2.5 thiol groups per active molecule, or an average of at least 3 thiol groups per active molecule. Further, the active molecules may have an average of from 1.5 to 9 thiol groups per active molecule, an average of from 3 to 8 thiol groups per active molecule, an average of from 2 to 4 thiol groups per active molecule, or an average of from 4 to 8 thiol groups per active molecule.

Generally, the location of the thiol group within the active molecule may not be particularly important and will be dictated by the method used to produce the active molecule. In embodiments wherein the thiol ester may be produced by contacting an unsaturated ester with hydrogen sulfide, forming a mercaptanized unsaturated ester, the position of the thiol group will be dictated by the position of the carbon-carbon double bond. When the carbon-carbon double bond is an internal carbon-carbon double bond, the method of producing the thiol ester will result in a secondary thiol group. However, when the double bond is located at a terminal position it may be possible to choose reaction conditions to produce a thiol ester including either a primary thiol group or a secondary thiol group.

Some methods of producing the thiol ester composition may create sulfur containing functional groups other than a thiol group. For example, in some methods for producing thiol esters, more than one thiol group may react, producing a polysulfide linkage, or —S—S— group, connecting two carbon chains. When the subsequent thiol group reacts with the carbon-carbon double bond in a second ester group of the same unsaturated ester molecule, the sulfide may contain at least one ester group within a ring structure. Within this specification, this type of sulfide may be referred to as a simple sulfide. However, when the subsequent thiol group reacts with the carbon-carbon double bond within the same ester group, the sulfide does not contain an ester group within the ring structure. Within this specification, this type of sulfide may be referred to as a cyclic sulfide. The cyclic sulfide rings that may be produced include a tetrahydrothiopyran ring, a thietane ring, or a thiophane ring (tetrahydrothiophene ring).

It may desirable to control the average amount of sulfur present as cyclic sulfide in the active molecules. For example, the average amount of sulfur present as cyclic sulfide in the active molecules may be less than 30 mole percent, less than 20 mole percent, less than 10 mole percent, less than 5 mole percent or less than 2 mole percent. Further, it may be desirable to control the molar ratio of cyclic sulfides to thiol groups. For example, the average molar ratio of cyclic sulfide groups to thiol groups per thiol ester may be less than 1.5, less than 1, less than 0.5, less than 0.25 or less than 0.1.

In embodiments, the active molecules may include thiol esters made from natural source oils, as described herein. When the active molecules includes thiol esters made from natural source oils, functional groups that are present in the thiol esters may be described in a “per active molecule” basis or in a “per triglyceride” basis. The thiol esters may have substantially the same properties as the thiol ester composition, such as the molar ratios and other independent descriptive elements described herein. Generally, the average number of thiol groups per triglyceride in the thiol containing natural source oil may be greater than about 1.5, greater than about 2, or greater than about 2.5, and may range from about 1.5 to about 9, about 2 to about 7, or about 2.5 to about 5.

### Hydroxy Thiol Ester Composition

In an aspect, the reactive composition may include active molecules of a hydroxy thiol ester. The hydroxy thiol ester may be described using a number of methods. For example, the hydroxy thiol ester may be described by the types of functional groups present in the hydroxy thiol ester. In this functional description, the hydroxy thiol ester composition contains molecules having at least one ester group, at least one thiol group, and at least one hydroxy group. In other embodiments, the thiol ester composition may include thiol esters with and without additional groups, such as polysulfide linkages —Sₓ— wherein x is an integer greater than 1. When the thiol ester has a hydroxy group and a polysulfide linkage, the thiol ester may be referred to as crosslinked hydroxy thiol ester.

Alternatively, a hydroxy thiol ester may be described using a name that indicates the method by which it was formed. For example, a hydroxy thiol ester that may be produced by reacting hydrogen sulfide with an epoxidized unsaturated ester may be called a mercaptanized epoxidized unsaturated ester. The mercaptanized epoxidized unsaturated ester may be further described utilizing the function descriptor of the hydroxy thiol ester present in the mercaptanized epoxidized ester. Compounds that fit the hydroxy thiol ester composition description do not always fit the mercaptanized epoxidized unsaturated ester description.

For example, mercaptanized castor oil may be described as a hydroxy thiol ester by virtue of having at least one ester group, at least one thiol group, and at least one hydroxy group. Mercaptanized castor oil, however, is not a mercaptanized epoxidized unsaturated ester, as it may be produced by contacting castor oil (which contains carbon-carbon double bonds and hydroxyl groups) with hydrogen sulfide. In contrast, a mercaptanized epoxidized castor oil may be a mercaptanized epoxidized unsaturated ester oil, formed by contacting hydrogen sulfide with epoxidized castor oil.

A hydroxy thiol ester molecule may be produced by reacting hydrogen sulfide with an epoxidized unsaturated ester as described in the '675 applications. When the thiol ester may be produced by this technique, the material produced may be called a mercaptanized epoxidized ester. In a mercaptanized epoxidized ester, hydroxyl groups and the thiol groups may on adjacent carbons, in which case the active hydrogen groups may be referred to as an α-hydroxy thiol group. Because the epoxidized unsaturated ester may contain multiple epoxide groups, epoxide group reactivity and statistical probability dictate that not all hydroxy thiol ester molecules will have the same number of hydroxyl groups, thiol groups, α-hydroxy thiol groups, sulfides, cyclic sulfides, molar ratio of cyclic sulfides to thiol groups, molar ratio of epoxide groups to thiol groups, molar ratio of epoxide groups to α-hydroxy thiol groups, weight percent thiol sulfur, and/or other disclosed quantities of functional groups and their molar ratios as the epoxidized unsaturated ester.

Accordingly, many of these properties will be discussed as an average number or ratio per hydroxy thiol ester molecule. It may be desirable to control the content of thiol sulfur present in the hydroxy thiol ester. Because it may be difficult to ensure that the hydrogen sulfide reacts with every epoxide group within the epoxidized unsaturated ester, certain hydroxy thiol ester molecules may have more or less thiol groups than other molecules. Thus, the weight percent of thiol groups may be stated as an average weight percent across all hydroxy thiol ester molecules.

In various embodiments of the present techniques, the reactive composition may include hydroxy thiol ester molecules that have an average of at least 1 ester group and an average of at least 1 α-hydroxy thiol group per molecule or an average of at least 1.5 ester groups and an average of at least 1.5 α-hydroxy thiol groups per hydroxy thiol ester molecule. Alternatively, the hydroxy thiol ester may include at least one ester, at least one thiol group, and at least one hydroxy group. Thus, the reactive composition may include hydroxy thiol ester molecules that have an average of at least 1.5 ester groups, an average of at least one thiol group, and an average of at least 1.5 hydroxyl groups per hydroxy thiol molecule.

A hydroxy thiol ester may be prepared from either an epoxidized unsaturated ester or an unsaturated ester. Thus, the hydroxy thiol ester may contain the same number of ester groups as the epoxidized unsaturated ester or unsaturated ester. For example, the hydroxy thiol ester molecules may have an average of at least 1.5 ester groups per hydroxy thiol ester molecule, an average of at least 2 ester groups per hydroxy thiol ester molecule, an average of at least 2.5 ester groups per hydroxy thiol ester molecule or an average of at least 3 ester groups per hydroxy thiol ester molecule. Further, the hydroxy thiol ester molecules may have an average of from 1.5 to 8 ester groups per hydroxy thiol ester molecule, an average of from 2 to 7 ester groups per hydroxy thiol ester molecule, an average of from 2.5 to 5 ester groups per hydroxy thiol ester molecule or an average of from 3 to 4 ester groups per hydroxy thiol ester molecule. In embodiments, the reactive composition may include hydroxy thiol ester molecules having an average of about 3 ester groups per hydroxy thiol ester molecule or an average of about 4 ester groups per hydroxy thiol ester molecule.

The hydroxy thiol ester molecules have at least one thiol group per hydroxy thiol ester molecule. For example, the hydroxy thiol ester molecules may have an average of at least 1.5 thiol groups per hydroxy thiol ester molecule, an average of at least 2 thiol groups per hydroxy thiol ester molecule, an average of at least 2.5 thiol groups per hydroxy thiol ester molecule or an average of at least 3 thiol groups per hydroxy thiol ester molecule. Further, the hydroxy thiol ester molecules may have an average of from 1.5 to 9 thiol groups per hydroxy thiol ester molecule, an average of from 3 to 8 thiol groups per hydroxy thiol ester molecule, an average of from 2 to 4 thiol groups per hydroxy thiol ester molecule or an average of from 4 to 8 thiol groups per hydroxy thiol ester.

The hydroxy thiol ester molecules have an average of at least 1 hydroxyl group per hydroxy thiol ester molecule. For example, the hydroxy thiol ester molecules may have an average of at least 1.5 hydroxyl groups per hydroxy thiol ester molecule, an average of at least 2 hydroxyl groups per hydroxy thiol ester molecule, an average of at least 2.5 hydroxyl groups per hydroxy thiol ester molecule or an average of at least 3 hydroxyl groups per hydroxy thiol ester molecule. Further, the thiol ester molecules may have an average of from 1.5 to 9 hydroxyl groups per hydroxy thiol ester molecule, an average of from 3 to 8 hydroxyl groups per hydroxy thiol ester molecule, an average of from 2 to 4 hydroxyl groups per hydroxy thiol ester molecule or an average of from 4 to 8 hydroxyl groups per hydroxy thiol ester molecule.

The number of hydroxyl groups may be stated as an average molar ratio of hydroxyl groups to thiol groups. The molar ratio of hydroxyl groups to thiol groups may be at least 0.25. For example, the molar ratio of hydroxyl groups to thiol groups may be at least 0.5, at least 0.75, at least 1.0, at least 1.25 or at least 1.5. Further, the molar ratio of hydroxyl groups to thiol groups may range from 0.25 to 2.0, from 0.5 to 1.5 or from 0.75 to 1.25.

The hydroxy thiol ester may have an average of at least 1 α-hydroxy thiol group per hydroxy thiol ester molecule. For example, the hydroxy thiol ester molecules may have an average of at least 1.5 α-hydroxy thiol groups per hydroxy thiol ester molecule, an average of at least 2 α-hydroxy thiol groups per hydroxy thiol ester molecule, an average of at least 2.5 α-hydroxy thiol groups per hydroxy thiol ester molecule or an average of at least 3 α-hydroxy thiol groups per hydroxy thiol ester molecule. Further, the hydroxy thiol ester molecules may have an average of from 1.5 to 9 α-hydroxy thiol groups per molecule, an average of from 3 to 8 α-hydroxy thiol groups molecule, an average of from 2 to 4 α-hydroxy thiol groups per molecule or an average of from 4 to 8 α-hydroxy thiol groups per molecule. In various embodiments, at least 20 percent of the total side chains may include the α-hydroxy thiol group. Alternatively, an α-hydroxy thiol group may be found in at least 40 percent of the total side chains, at least 60 percent of the total side chains, at least 70 percent of the total side chains or in at least 80 percent of the total side chains.

In various embodiments, the epoxidized unsaturated ester used in the synthesis of the hydroxy thiol ester may be produced from an epoxidized natural source oil. Because the natural source oils generally have particular numbers of ester groups, the hydroxy thiol ester will have about the same number of ester groups as the natural source oil. Other independent properties that are described herein may be used to further describe the hydroxy thiol ester.

In other embodiments, the epoxidized unsaturated ester used to produce the hydroxy thiol ester may produced from synthetic (or semi-synthetic) unsaturated ester oils. Because synthetic ester oils may be made with particular numbers of ester groups, the hydroxy thiol ester would have about the same number of ester groups as the synthetic ester oil. Other independent properties of the unsaturated ester, whether the unsaturated ester includes natural source or synthetic oils, may be used to further describe the hydroxy thiol ester composition.

Examples of suitable hydroxy thiol esters include but are not limited to mercaptanized epoxidized vegetable oils, mercaptanized epoxidized soybean oil, mercaptanized epoxidized castor oil and mercaptanized castor oil. Other suitable mercaptanized epoxidized esters are described in the '675 applications and are to be considered within the scope of the present techniques.

### Cross-Linked Thiol Ester Compositions

In an aspect, the reactive compositions may include active molecules of a cross-linked thiol ester. Generally, the cross-linked thiol ester molecules are oligomers of thiol esters that are connected together by polysulfide linkages —Sₓ— wherein x is an integer greater than 1. As the cross-linked thiol ester may be described as an oligomer of thiol esters, the thiol esters may be described as the monomer from which the cross-linked thiol esters are produced. In embodiments, the cross-linked thiol ester may be produced from a mercaptanized unsaturated ester and may be called a cross-linked mercaptanized unsaturated ester. In other embodiments, the cross-linked thiol ester may be produced from a hydroxy thiol ester and may be called a crossed linked hydroxy thiol ester. In yet other embodiments, the crosslinked thiol ester may be produced from a mercaptanized epoxidized unsaturated ester and may be called a cross-linked mercaptanized epoxidized thiol ester.

The cross-linked thiol ester molecules may include a thiol ester oligomer having at least two thiol ester monomers connected by a polysulfide linkage having a structure —Sₓ— wherein x is an integer greater than 1. In an aspect, the polysulfide linkage may be the polysulfide linkage —Sₓ—, wherein x is 2, 3, 4, or mixtures thereof. In other embodiments, x may be 2, 3 or 4. For example, the cross-linked thiol ester molecules may include a thiol ester oligomer having at least 3 thiol ester monomers connected by polysulfide linkages, at least 5 thiol ester monomers connected by polysulfide linkages, at least 7 thiol ester monomers connected by polysulfide linkages or at least 10 thiol ester monomers connected by polysulfide linkages. Further, the cross-linked thiol ester molecules may include a thiol ester oligomer having from 3 to 20 thiol ester monomers connected by polysulfide linkages, from 5 to 15 thiol ester monomers connected by polysulfide linkages or from 7 to 12 thiol ester monomers connected by polysulfide linkages.

The cross-linked thiol ester molecules may include both thiol ester monomers and thiol ester oligomers. For example, the cross-linked thiol ester composition may have a combined thiol ester monomer and thiol ester oligomer average molecular weight greater than 2,000, greater than 5,000 or greater than 10,000. Further, the cross-linked thiol ester composition may have a combined thiol ester monomer and thiol ester oligomer average molecular weight ranging from 2,000 to 20,000, from 3,000 to 15,000 or from 7,500 to 12,500. The thiol ester monomers and thiol ester oligomers may have a total thiol sulfur content greater than 0.5 weight percent, greater than 1 weight percent, greater than 2 weight percent or greater than 4 weight percent. Further, the thiol ester monomers and the thiol ester oligomers may have a total thiol sulfur content from 0.5 weight percent to 8 weight percent, from 4 weight percent to 8 weight percent or 0.5 weight percent to 4 weight percent.

### Unsaturated Esters

The unsaturated ester molecules used as a feedstock to produce some of the active molecules described above may be described using a number of different methods. For example, the unsaturated ester may be described by the number of ester groups and the number of carbon-carbon double bonds that include each unsaturated ester oil molecule. Suitable unsaturated esters used to produce the reactive compositions described herein include at least 1 ester group and at least 1 carbon-carbon double bond. However, beyond this requirement, the number of ester groups and carbon-carbon double bonds including the unsaturated esters are independent elements and may be varied independently of each other. Thus, the unsaturated esters may have any combination of the number of ester groups and the number of carbon-carbon double bonds described separately herein. Suitable unsaturated esters may also contain additional functional groups such as hydroxyl, aldehyde, ketone, epoxy, ether, aromatic groups, and combinations thereof. For example, the unsaturated ester castor oil has hydroxyl groups in addition to carbon-carbon double bonds and ester groups. Other suitable unsaturated esters will be apparent to those of skill in the art and are to be considered within the scope of the present techniques.

The unsaturated ester molecules may include at least one ester group. For example, the unsaturated ester may include 2 ester groups, 3 ester groups or 4 ester groups. Further, the unsaturated ester molecules may include from 2 to 8 ester groups, from 2 to 7 ester groups or from 3 to 5 ester groups. In embodiments, the unsaturated ester may include from 3 to 4 ester groups.

The unsaturated ester may also include a mixture of unsaturated ester molecules. For a mixture, the number of ester groups is best described as an average number of ester groups per unsaturated ester molecule. For example, the unsaturated esters may have an average of at least 1.5 ester groups per unsaturated ester molecule, an average of at least 2 ester groups per unsaturated ester molecule, an average of at least 2.5 ester groups per unsaturated ester molecule or an average of at least 3 ester groups per unsaturated ester molecule. Further, the unsaturated esters may have an average of from 1.5 to 8 ester groups per unsaturated ester molecule, an average of from 2 to 7 ester groups per unsaturated ester molecule, an average of from 2.5 to 5 ester groups per unsaturated ester molecule or an average of from 3 to 4 ester groups per unsaturated ester molecule. In embodiments, the unsaturated esters may have an average of about 3 ester groups per unsaturated ester molecule or an average of about 4 ester groups per unsaturated ester molecule.

The unsaturated ester includes at least one carbon-carbon double bond per unsaturated ester molecule. For example, the unsaturated ester may include at least 2 carbon-carbon double bonds, at least 3 carbon-carbon double bonds or at least 4 carbon-carbon double bonds. Further, the unsaturated ester may include from 2 to 9 carbon-carbon double bonds, from 2 to 4 carbon-carbon double bonds, from 3 to 8 carbon-carbon double bonds or from 4 to 8 carbon-carbon double bonds.

For mixtures of unsaturated ester molecules, or mixtures of unsaturated molecules derived from natural source oils, the number of carbon-carbon double bonds in the mixture may best be described as an average number of carbon-carbon double bonds per unsaturated ester molecule. For example, the unsaturated esters may have an average of at least 1.5 carbon-carbon double bonds per molecule, an average of at least 2 carbon-carbon double bonds per molecule, an average of at least 2.5 carbon-carbon double bonds per molecule or an average of at least 3 carbon-carbon double bonds per molecule. Further, the unsaturated esters may have average of from 1.5 to 9 carbon-carbon double bonds per unsaturated ester molecule, an average of from 3 to 8 carbon-carbon double bonds per molecule, an average of from 2 to 4 carbon-carbon double bonds per molecule or an average of from 4 to 8 carbon-carbon double bonds per molecule.

In addition to the number of ester groups and the number of carbon-carbon double bonds present in the unsaturated ester molecules, the disposition of the carbon-carbon double bonds in unsaturated ester molecules having 2 or more carbon-carbon double bonds may be a consideration. For example, where the unsaturated ester molecules have 2 or more carbon-carbon double bonds, the carbon-carbon double bonds may be conjugated. In another example, the carbon-carbon double bonds may be separated from each other by only one carbon atom. When two carbon-carbon double bonds are separated by a carbon atom having two hydrogen atoms attached to it, e.g. a methylene group, these carbon-carbon double bonds may be termed as methylene interrupted double bonds. In other molecules, the carbon-carbon double bonds may isolated, e.g. the carbon-carbon double bonds are separated from each other by 2 or more carbon atoms. Finally, the carbon-carbon double bonds may be conjugated with a carbonyl group.

The unsaturated ester utilized to produce the thiol ester utilized in aspects of the current techniques may be any unsaturated ester having the number of ester groups and carbon-carbon double bonds per unsaturated ester described herein. The unsaturated ester may be derived from natural sources, synthetically produced from natural source raw materials, produced from synthetic raw materials, produced from a mixture of natural and synthetic materials, or a combination thereof.

### Unsaturated Natural Source Oils

In embodiments of the present techniques, the unsaturated ester may be an unsaturated natural source oil. The unsaturated natural source oil may be a triglyceride derived from either naturally occurring or genetically modified nut, vegetable, plant, and animal sources. For example, the unsaturated natural source oil may be tallow, olive, peanut, castor bean, sunflower, sesame, poppy, seed, palm, almond seed, hazelnut, rapeseed, soybean, corn, safflower, canola, cottonseed, camelina, flaxseed, or walnut oil. From these choices, any one or any combinations of unsaturated natural source oils may be selected on the basis of the desired properties, cost or supply. For example, the natural source oil may be selected from the group consisting of soybean, rapeseed, canola, or corn oil. Castor bean oil may be selected due to a large available supply in some parts of the world. Soybean oil may be selected due to a low cost and/or abundant supply. Finally, other oils may be selected to provide appropriate properties in the final composition. For example, from the choices listed above, certain unsaturated natural source oils may be selected to minimize the number of methylene interrupted double bonds, as previously described, which may result in higher thiol group and/or hydroxyl group content.

### Synthetic Unsaturated Esters

In addition to, or instead of, natural source oils, synthetic unsaturated ester oils may used to produce the active molecules containing thiol groups, as discussed above. These synthetic unsaturated esters may be produced using any methods for producing an ester group known to one of ordinary skill in the art. For example, the term “ester group” indicates a moiety formed from the reaction of a hydroxy group with a carboxylic acid or a carboxylic acid derivative. Typically, the esters may be produced by reacting an alcohol (a hydrocarbon molecule containing an —OH group) with a carboxylic acid, transesterification of carboxylic acid ester with an alcohol, reacting an alcohol with a carboxylic acid anhydride, or reacting an alcohol with a carboxylic acid halide. The alcohol, unsaturated carboxylic acid, unsaturated carboxylic acid ester, unsaturated carboxylic acid anhydride raw materials for the production of the unsaturated ester oil may be derived from natural sources, synthetic sources, genetically modified natural sources or any combinations thereof.

The alcohols and the unsaturated carboxylic acids, unsaturated carboxylic acid esters or unsaturated carboxylic acid anhydrides used to produce the unsaturated esters used as a feedstock in various aspects of this invention are independent elements. That is, these elements may be varied independently of each other and thus, may be used in any combination to produce an unsaturated ester utilized a feedstock to produce the compositions described in this application or as a feedstock for the processes described in this application. For example, a polyol, i.e., a hydrocarbon molecule containing multiple hydroxyl groups, may be used to form molecules having multiple ester groups. A polyol used to produce the unsaturated ester oil may be any polyol or mixture of polyols capable of reacting with an unsaturated carboxylic acid, unsaturated carboxylic acid ester, carboxylic acid anhydride, or carboxylic acid halide under reaction conditions apparent to one of ordinary skill in the art.

The number of carbon atoms in the polyol may be varied. For example, the polyol used to produce the unsaturated ester may have from 2 to 20 carbon atoms, from 2 to 10 carbon atoms, from 2 to 7 carbon atoms or from 2 to 5 carbon atoms. Further, the polyol may be a mixture of polyols having an average of 2 to 20 carbon atoms, an average of from 2 to 10 carbon atoms, an average of 2 to 7 carbon atoms or an average of 2 to 5 carbon atoms.

The polyol used to produce an unsaturated ester may have any number of hydroxyl groups needed to produce an unsaturated ester as described herein. For example, the polyol may have 2 hydroxyl groups, 3 hydroxyl groups, 4 hydroxyl groups, 5 hydroxyl groups, 6 hydroxyl groups, or more. Further, the polyol may have from 2 to 8 hydroxyl groups, from 2 to 4 hydroxyl groups or from 4 to 8 hydroxyl groups.

The polyol used to produce an unsaturated ester may be a mixture of polyols. In this case, an average number of hydroxyl groups may be used to describe the mixture. For example, the mixture of polyols may have an average of at least 1.5 hydroxyl groups per polyol molecule, an average of at least 2 hydroxyl groups per molecule, an average of at least 2.5 hydroxyl groups per molecule, an average of at least 3.0 hydroxyl groups per molecule or an average of at least 4 hydroxyl groups per molecule. Further, the mixture of polyols may have an average of 1.5 to 8 hydroxyl groups per polyol molecule, an average of 2 to 6 hydroxyl groups per molecule, an average of 2.5 to 5 hydroxyl groups per molecule, an average of 3 to 4 hydroxyl groups per molecule, an average of 2.5 to 3.5 hydroxyl groups per molecule or an average of 2.5 to 4.5 hydroxyl groups per molecule.

Suitable polyols that may be used in embodiments of the present techniques include 1,2-ethanediol, 1,3-propanediol, 1,4-butanediol, 1,5-pentanediol, 1,6-hexanediol, dimethylolpropane, neopentyl glycol, 2-propyl-2-ethyl-1,3-propanediol, 1,2-propanediol, 1,3-butanediol, diethylene glycol, triethylene glycol, polyethylene glycol, dipropylene glycol, tripropylene glycol, polypropylene glycol, cyclohexanedimethanol, 1,3-dioxane-5,5-dimethanol, 1,4-xylylenedimethanol, 1-phenyl-1,2-ethanediol, trimethylolpropane, trimethylolethane, trimethylolbutane, glycerol, 1,2,5-hexanetriol, pentaerythritol, ditrimethylolpropane, diglycerol, ditrimethylolethane, 1,3,5-trihydroxybenzene, 1,4-xylylenedimethanol, 1-phenyl-1,2-ethanediol, or any combination thereof. Any single polyol or combination of these polyols may be selected, depending on cost, availability and the properties desired. For example, the polyol may be glycerol, pentaerythritol or a mixture thereof, which are both in large supply and have multiple hydroxyl groups.

The carboxylic acid component of the unsaturated ester oil may be any carboxylic acid or mixture of carboxylic acids including a carbon-carbon double bond. Further, the carboxylic acid component may be any mixture of saturated carboxylic acid and unsaturated carboxylic acid that produces an unsaturated ester oil meeting the feedstock requirement described herein. Thus, the carboxylic acid or carboxylic acid mixture used to produce the synthetic unsaturated ester oil may be described as having an average number of a specified element per carboxylic acid.

For example, independent elements of the carboxylic acid include the average number of carboxylic acid groups per carboxylic acid molecule, the average number of carbon atoms present in the carboxylic acid, and the average number of carbon-carbon double bonds per carboxylic acid. Additional independent elements include the position of the double bond in the carbon chain and the relative position of the double bonds with respect to each other when there are multiple double bonds.

Specific carboxylic acids used to produce the unsaturated ester oil may have from 3 to 30 carbon atoms per carboxylic acid molecule. The carboxylic acid may be linear, branched or a mixture thereof. The carboxylic acid may also include additional functional groups including alcohols, aldehydes, ketones, and epoxides, among others. For example, suitable carboxylic acids that may be used as a component of unsaturated carboxylic acid composition may have from about 3 to about 30 carbon atoms, 8 to 25 carbon atoms or from 12 to 20 carbon atoms. Further, the carboxylic acids including the unsaturated carboxylic acid composition may have an average of 2 to 30 carbon atoms, an average of 8 to 25 carbon atoms or an average of from 12 to 20 carbon atoms.

The carbon-carbon double bond may be located anywhere along the length of the molecule. For example, the double bond may be located at a terminal position or may be located at internal position. Further, the carboxylic acid or mixture of carboxylic acids may include both terminal and internal carbon-carbon double bonds. The double bond can also be described by indicating the number of substituents that are attached to the carbon-carbon double bond. For example, the carbon-carbon double bond may be mono-substituted, disubstituted, trisubstituted, tetrasubstituted, or a mixture of unsaturated carboxylic acids that may have any combination of monosubstituted, disubstituted, trisubstituted and tetrasubstituted carbon-carbon double bonds.

Suitable unsaturated carboxylic acids include acrylic, agonandoic, agonandric, alchornoic, ambrettolic, angelic, asclepic, auricolic, avenoleic, axillarenic, brassidic, caproleic, cetelaidic, cetoleic, civetic, coriolic, coronaric, crepenynic, densipolic, dihomolinoleic, dihomotaxoleic, dimorphecolic, elaidic, ephedrenic, erucic, gadelaidic, gadoleic, gaidic, gondolo, gondoleic, gorlic, helenynolic, hydrosorbic, isoricinoleic, keteleeronic, labellenic, lauroleic, lesquerolic, linelaidic, linderic, linoleic, lumequic, malvalic, mangold's acid, margarolic, megatomic, mikusch's acid, mycolipenic, myristelaidic, nervoic, obtusilic, oleic, palmitelaidic, petroselaidic, petroselinic, phlomic, physeteric, phytenoic, pyrulic, ricinelaidic, rumenic, selacholeic, sorbic, stearolic, sterculic, sterculynic, stillingic, strophanthus, tariric, taxoleic, traumatic, tsuduic, tsuzuic, undecylenic, vaccenic, vernolic, ximenic, ximenynic, ximenynolic, and combinations thereof. In further embodiments, suitable unsaturated carboxylic acids include oleic, palmitoleic, ricinoleic, linoleic, or any combinations thereof. Any of these acids, individually or in any combination, may be chosen depending on availability or the properties desired for the final unsaturated ester composition. For example, combinations of these acids may be selected to form synthetic triglycerides when reacted when glycerol. The synthetic triglycerides may have a similar number of carbon-carbon double bonds as the natural triglycerides, and thus provide similar properties to the natural triglycerides discussed earlier.

The unsaturated ester may also be produced by transesterification of a simple ester of the carboxylic acid or mixture of carboxylic acids described herein with the polyol compositions described herein. Specifically, the simple ester may be a methyl or ethyl ester of the carboxylic acid or mixture of methyl and ester of the carboxylic acids. Alternatively, the simple carboxylic acid ester may be a methyl ester of the carboxylic acids described herein.

### Epoxidized Unsaturated Esters

In addition to the molecules described above, epoxidized unsaturated ester molecules may be used to produce ester molecules containing both thiol groups and hydroxyl groups, i.e., hydroxyl thiol esters, as described above. For example, the reaction of an epoxidized carbon-carbon double bond, i.e., an epoxy group, with hydrogen sulfide may be used to produce an α-hydroxy thiol group (i.e., a hydroxyl group and a thiol group on adjacent carbon atoms) as described previously. Generally, an epoxidized unsaturated ester may be obtained by epoxidizing any unsaturated ester described herein. The unsaturated ester oil may be derived from natural sources, synthetically produced from natural source raw materials, produced from synthetic raw materials, produced from a mixture of natural and synthetic materials, or a combination thereof.

An epoxidized unsaturated ester may have at least one epoxide group. For example, an epoxidized unsaturated ester may have at least 2 epoxide groups, at least 3 epoxide groups or at least 4 epoxide groups. Further, an epoxidized unsaturated ester may include from 2 to 9 epoxide groups, from 2 to 4 epoxide groups, from 3 to 8 epoxide groups or from 4 to 8 epoxide groups.

A mixture of epoxidized unsaturated esters may be formed from the epoxidation reaction, which may be described by the average number of epoxide groups per epoxidized unsaturated ester molecule. For example, the epoxidized unsaturated esters may have an average of at least 1.5 epoxide groups per epoxidized unsaturated ester molecule, an average of at least 2 epoxide groups per molecule, an average of at least 2.5 epoxide groups per molecule or an average of at least 3 epoxide groups per molecule. Further, the epoxidized unsaturated esters may have an average of from 1.5 to 9 epoxide groups per epoxidized unsaturated ester molecule, an average of from 3 to 8 epoxide groups per molecule, an average of from 2 to 4 epoxide groups per molecule or an average of from 4 to 8 epoxide groups per molecule.

In embodiments of the present techniques, the epoxidized unsaturated ester may be an epoxidized unsaturated natural source oil. The unsaturated natural source oil may be a triglyceride derived from either naturally occurring or genetically modified nut, vegetable, plant or animal sources. For example, the epoxidized natural source oil may be tallow, olive, peanut, castor bean, sunflower, sesame, poppy, seed, palm, almond seed, hazelnut, rapeseed, canola, soybean, corn, safflower, canola, cottonseed, camelina, flaxseed, or walnut oil. As previously discussed, any single oil or combination of oils may be selected from this list, depending on the desired cost, properties or availability.

Monomer Compositions that Include Isocyanate Groups

Generally, the monomer composition includes, or may consist essentially of, monomer molecules having at least one isocyanate group. In embodiments forming a polymer, the isocyanate composition may include monomer molecules having multiple isocyanate groups. The monomer composition may also include a mixture of monomer molecules. When the monomer composition includes a mixture of monomer molecules, the monomer molecules may have an average of at least 1.5 isocyanate groups per molecule, an average of at least 2 isocyanate groups per molecule, an average of at least 2.5 isocyanate groups per molecule or an average of at least 3 isocyanate groups per molecule. Further, the monomer molecules may have an average of from 1.5 to 12 isocyanate groups per molecule, an average of from 1.5 to 9 isocyanate groups per molecule, an average of from 2 to 7 isocyanate groups per molecule, an average of from 2 to 5 isocyanate groups per molecule or an average of from 2 to 4 isocyanate groups per isocyanate molecule. In embodiments, the isocyanate composition may include aliphatic isocyanates, cycloaliphatic isocyanates, aromatic isocyanates, or any combination thereof.

Aliphatic isocyanate monomer molecules that may be included in the monomer composition include, for example, n-butyl isocyanate, n-hexyl isocyanate, ethylene diisocyanate, 1,3-trimethylene diisocyanate, 1,4-tetramethylene diisocyanate, 1,6-hexamethylene diisocyanate, 1,7-heptamethylene isocyanate, 1,8-octamethylene diisocyanate, 1,9-nonamethylene diisocyanate, 1,10-decamethylene diisocyanate, 1,11-undecamethylene diisocyanate, 1,12-dodecamethylene diisocyanate, 2,2′-dimethylpentane diisocyanate, 2,2,4-trimethyl-1,6-hexamethylene diisocyanate, 2,4,4-trimethylhexamethylene diisocyanate, 1,6,11-undecane triisocyanate, 1,3,6-hexamethylene triisocyanate, 1,8-diisocyanato-4-(isocyanatomethyl)octane, 2,5,7-trimethyl-1,8-diisocyanato-5-(isocyanatomethyl)octane, or any combination thereof. The monomer composition may include any one type or any combination of these molecules, depending on the cost, availability and properties desired.

Cycloaliphatic isocyanate monomer molecules that may be included in the monomer composition include, for example, 1-isocyanato-2-isocyanatomethyl cyclopentane, 1,3-cyclohexane diisocyanate, 1,4-cyclohexane diisocyanate, 2,4-methylcyclohexane diisocyanate, 2,6-methylcyclohexane diisocyanate, 1,2-dimethylcyclohexane diisocyanate, 1,4-dimethylcyclohexane diisocyanate, isophorone diisocyanate (IPDI), 1-isocyanato-1-methyl-4(3)-isocyanatomethyl cyclohexane, 1,3-bis-(isocyanato-methyl)cyclohexane, 1,4-bis(isocyanato-methyl)cyclohexane, 2,4′-dicyclohexylmethane diisocyanate, 4,4′-dicyclohexylmethane diisocyanate (hydrogenated MDI, HMDI), 2,2′-dimethyldicyclohexylmethane diisocyanate, 4,4′-bis(3-methylcyclohexyl)methane diisocyanate, or any combination thereof. As discussed above, the monomer composition may include any one type or any combination of these molecules, depending on the cost, availability and properties desired.

Aromatic isocyanate monomer molecules that may be included in the monomer composition include, for example, 1,3-phenylene diisocyanate, 1,4-phenylene diisocyanate, 2,4-tolylene diisocyanate (TDI), 2,5-toluene diisocyanate 2,6-tolylene diisocyanate, tolylene-α,4-diisocyante, 1,3-xylylene diisocyanate, 1,4-xylylene diisocyanate, diethylphenylene diisocyanate, diisopropylphenylene diisocyanate, trimethylbenzene triisocyanate, α,α,α′,α′-tetramethyl-1,3-xylylene diisocyanate, α,α,α′,α′-tetramethyl-1,4-xylylene diisocyanate, mesitylene triisocyanate, benzene triisocyanate, 1,5-diisocyanato naphthalene, methylnaphthalene diisocyanate, bis(isocyanatomethyl)naphthalene, biphenyl diisocyanate, 2,4′-diphenylmethane diisocyanate, 4,4′-diphenylmethane diisocyanate (MDI), polymeric 4,4′-diphenylmethane diisocyanate (polymeric MDI, PMDI), 3,3′-dimethyl-diphenylmethane-4,4′-diisocyanate, bibenzyl-4,4′-diisocyanate, bis(isocyanatophenyl)ethylene, triphenylmethane triisocyanate, bis(isocyanatoethyl)benzene, bis-(isocyanatopropyl)benzene, bis(isocyanatobutyl)benzene, naphthalene triisocyanate, diphenylmethane-2,4,4′-triisocyanate, 3-methyldiphenylmethane-4,6,4′-triisocyanate, 4-methyldiphenyl-methane-3,5,2′,4′,6′-pentaisocyanate, tetrahydronaphthylene diisocyanate, or any combination thereof. As discussed above, the monomer composition may include any one type or any combination of these molecules, depending on the cost, availability and properties desired.

### Solvents and Other Components

The compositions discussed above may contain numerous other materials to facilitate the reactions or the use of the compounds, or to adjust the properties of the final compositions. These additional components may include, for example, solvents or property modification agents, among others. For example, a solvent may be added to the thiourethane polymer composition during synthesis or afterwards. The solvent may be useful in adjusting the viscosity of the thiourethane polymer composition. Some solvents can lower the viscosity of the thiourethane polymer composition to enable the composition to be applied more easily.

The solvent may be a hydrocarbon solvent, a halogenated hydrocarbon solvent, a ketone solvent, a carbonate solvent, an ester solvent, an ether solvent, or any combination thereof. For example, the solvent may include a C₄ to C₂₀ saturated hydrocarbon, a C₄ to C₁₀ saturated hydrocarbon, a C₆ to C₂₀ aromatic hydrocarbon, or a C₆ to C₂₀ aromatic hydrocarbon. Other solvents that may be used include a C₁ to C₁₅ halogenated hydrocarbon, a C₁ to C₁₀ halogenated hydrocarbon, a C₁ to C₅ halogenated hydrocarbon. Suitable solvents may also include a C₁ to C₁₀ ketone, a C₁ to C₅ ketone, a C₁ to C₁₀ carbonate, a C₁ to C₅ carbonate, a C₁ to C₁₀ ester, a C₁ to C₅ ester, a C₁ to C₁₀ ether; or a C₁ to C₅ ether.

Suitable saturated hydrocarbon solvents that may be utilized include, for example, pentane, n-hexane, hexanes, cyclopentane, cyclohexane, n-heptane, heptanes, n-octane, and petroleum distillate. Suitable aromatic hydrocarbon solvents that may be utilized include, for example, benzene, toluene, mixed xylenes, ortho-xylene, meta-xylene, para-xylene, and ethylbenzene. Suitable halogenated solvents that may be utilized include, for example, carbon tetrachloride, chloroform, methylene chloride, dichloroethane, trichloroethane, chlorobenzene, and dichlorobenzene. Suitable ketone solvents that may be utilized include, for example, acetone, and methyl ethyl ketone. Suitable carbonate solvents that may be utilized include, for example, dimethyl carbonate, diethyl carbonate, propylene carbonate, and glycerol carbonate. Suitable ester solvents that may be utilized include, for example, methyl acetate, ethyl acetate, and butyl acetate. Suitable ether solvents that may be utilized, either singly or in any combination, include, but are not limited to, dimethyl ether, diethyl ether, methyl ethyl ether, diethers of glycols (e.g. dimethyl glycol ether), furans, dihydrofuran, substituted dihydrofurans, tetrahydrofuran (THF), tetrahydropyrans, 1,3-dioxanes, and 1,4-dioxanes. Other suitable solvents will be apparent to those of ordinary skill in the art and are to be considered within the scope of the present techniques.

The properties of the polymer may be modified by including a property modifying agent within one of the compositions used to produce the polymer. In this instance, the polymer may be described as a reaction product of a reactive composition, a monomer composition, a catalyst, and a property modifying agent. For example, a polyol may be added to the reactive composition as the polymer is being prepared. Such polyols may include polypropylene glycol or ethylene glycol, among others. Further, oligomeric reagents may be used in embodiments where flexibility may be needed, such as when the thiourethane polymer composition is being used as an adhesive or a sealant. For example, an oligomeric polyol, polyether, polyester, polyamines, polyether esters, or a combination thereof may be added.

The property modifying agent may also be used to provide other properties, such as strength and adhesion to the polymers produced in accordance with embodiments of the present techniques. The property modifying agent may also include one or more active hydrogen groups. For example, suitable property modifying agents may include trifunctional oligomers, tackifiers, polybutadiene, polyether amines (such as Jeffamine® polymers), ethers, urea, di(hydroxyethyl)disulfide (DIHEDS), among others. The property modifying agent may be added either during synthesis of the polymer or added immediately preceding or during the reaction of the polymer with additional components to form a final coating or adhesive. If the property modifying agent contains an active hydrogen group and is added during synthesis, it is believed that the resulting prepolymer composition will have slightly different properties than if the property modifying agent containing an active hydrogen group is added afterwards.

### Examples and Procedures

### Generating Polythiourethane Samples

The reactive composition used for generating the examples detailed below included active molecules of a mercaptanized epoxidized unsaturated ester, specifically a mercaptanized epoxidized soybean oil (mercapto hydroxyl soybean oil, MHSO). The monomer composition included monomer molecules of Desmodur N-75, an aliphatic, hexamethylene-based isocyanate available from Bayer. The catalyst compositions used included an amine catalyst (Desmorapid PP, available from Bayer, now as Addocat® PP), a tin catalyst (dibutyl tin dilaurate, DBTDL), or both. The amounts of the isocyanates and catalysts used are given in the tables, below. The isocyanate is expressed in a percentage concentration, which is relative to the number of active hydrogen groups present on the active molecules, e.g., the sum of the number of thiol and hydroxyl groups present).

The control used for comparison with the samples above was a commercially available clear polyurethane system, Desmophen 680 70/Desmodur N-75, using a tin/amine mixed catalyst for curing. The Desmophen 680 70 is a polyester polyol, available from Bayer. The control was generated by the procedure below, using 7.23 g of Desmodur N-75, 20.0 g of Desmophen 680 70, 12.0 g of anhydrous n-butyl acetate (to yield ˜50% solids formulation mixture by weight), and adding 0.04 g of amine catalyst and 0.02 g of DBTDL catalyst.

The same procedure was used for producing all of the samples, including the control. Specifically, this procedure started by weighing 20.0 g of MHSO into a reaction vessel, in this case a glass vial with Polyseal™ lined cap. The MHSO was diluted using anhydrous n-butyl acetate as a solvent. To this container, the amount of Desmodur N-75 needed to match the ratio in the tables below was added. The mixture was agitated at ambient temperature using a bench top vortex mixer. The desired amount of catalyst, as shown in the tables below, was added to the mixture, which was again mixed with the vortex mixer. The mixture was placed into a vacuum chamber, which was then sealed. The pressure in the vacuum chamber was slowly reduced to full vacuum to remove entrained gases.

After removal from the vacuum chamber, the mixture was poured into an appropriate mold for the test procedure desired or spread onto an appropriate substrate (metal or glass) and drawn out to the desired thickness. The application of the films to the substrates, by wet or dry procedures, was performed in accordance with ASTM procedure D 1640-95, “Standard Test Methods for Drying, Curing, or Film Formation of Organic Coatings at Room Temperature.” The sample was then allowed to cure for the times listed in the tables below, wherein each time listed as a day corresponded to a 24 hour period. Under certain conditions, the samples were heated to the temperature listed in the tables to accelerate the curing. After curing for the desired period, the samples were removed from the mold for testing or directly tested on the substrate surface.

### Test Procedures

A number of test procedures were used to determine the comparative properties of the samples generated by the procedures above. Specifically, the film thickness of films deposited on metal substrates was determined using ASTM Test procedure D 1186-01, “Standard Test Methods for Nondestructive Measurement of Dry Film Thickness of Nonmagnetic Coatings Applied to a Ferrous Base.” The thickness of films applied to glass substrates was determined by ASTM D 1400-00, “Standard Test Method for Nondestructive Measurement of Dry Film Thickness of Nonconductive Coatings Applied to a Nonferrous Metal Base.”

The adhesion of films to substrates was determined by ASTM D 3359-02, “Standard Test Methods for Measuring Adhesion by Tape Test,” and D 4541-02, “Standard Test Method for Pull-Off Strength of Coatings Using Portable Adhesion Testers.” The impact resistance of the film coatings was measured using ASTM D 6905-03, “Standard Test Method for Impact Flexibility of Organic Coatings.”

The flexibility of film coating was measured by ASTM D 522-93a(2001), “Standard Test Methods for Mandrel Bend Test of Attached Organic Coatings.” The hardness of the films was measured by two procedures, ASTM D 3363-89-05, “Standard Test Method for Film Hardness by Pencil Test,” and D 2134-93 (2001), “Test Method for Determining the Hardness of Organic Coatings with a Sward-Type Hardness Rocker” (hereinafter referred to as Sward Hardness).

The cure of the films was measured by ASTM D 4752-87-03, “Standard Test Method for Measuring MEK Resistance of Ethyl Silicate (Inorganic) Zinc-Rich Primers by Solvent Rub” (hereinafter referred to as MEK Rub). The solvent resistance of the films was measured by ASTM D 1308-87-02, “Standard Test Method for Effect of Household Chemicals on Clear and Pigmented Organic Finishes.” The gloss of the film coatings was measured at both 20° and 60° (as indicated in the data tables, below, following ASTM D 523-89 (1999), “Specular Gloss.” The abrasion resistance of the film coatings was measured using ASTM D 4060-90-07, “Standard Test Method for Abrasion Resistance of Organic Coatings by the Taber Abraser.”

The UV resistance of the film coatings was measured by ASTM D 4587-05, “Standard Practice for Fluorescent UV-Condensation Exposures of Paint and Related Coatings.” The color change, or yellowing, of the films upon exposure to light was measured by ASTM D 2244-05-07, “Standard Practice for Calculation of Color Tolerances and Color Differences from Instrumentally Measured Color Coordinates.” The water immersion resistance of the films was measured using ASTM D 870-02, “Standard Practice for Testing Water Resistance of Coatings Using Water Immersion.” The humidity resistance of the films was measured using ASTM D 2247-02, “Standard Practice for Testing Water Resistance of Coatings in 100% Relative Humidity.” The heat resistance of the film coatings was measured using ASTM D 2485-91 (2000), “Standard Test Methods for Evaluating Coatings For High Temperature Service.”

The films were also removed from the substrates for additional testing. The tensile properties of the films removed from the substrates were tested using ASTM D 882-02, “Standard Test Method for Tensile Properties of Thin Plastic Sheeting.”

Results from Film Curing Studies

Two studies were performed to compare the results for films cured at elevated temperatures with films cured at ambient temperature. The ambient temperature used for curing these films was about 25° C., and the procedures above were used for forming and testing the films. The results from the first study are shown in Table 1, below, and the results from the second study are shown in Tables 2-5, below. The amounts of catalyst used are shown in the tables. Furthermore, the amount of isocyanate is given in the table as the mole % of isocyanate based upon active hydrogen, e.g., the sum of the mole % of thiol groups and the mole % of hydroxyl groups.

The results in Table 1 show that films made from MHSO and Desmodur N-75 may not cure to full strength at ambient temperature with an amine catalyst alone or a tin catalyst alone. However, a full cure may be achieved at ambient temperature using a mixed catalyst composition, as indicated by the results for MEK rub for runs 13-16. Further, a comparison of the results for Sward hardness and/or MEK rub, for runs 15 and 16, at ambient temperature to the results for curing at 130° C., shows that a substantially complete cure may be achieved at room temperature within about 48 hours (Day 2). Even at lower catalyst amounts, as shown in runs 13 and 14, about 50% of the total strength is achieved within 48 hours. This is comparable to the strength achieved after 144 hours (6 days) at ambient using only an amine catalyst, as shown by runs 9 and 10.

A comparison of the results in runs 13-16 obtained for an ambient cure of the 100 mole % isocyanate runs to the results in runs 13-16 obtained for curing the formulation for 3 hours at 130° C. indicated that a significant portion of the total strength, e.g., greater than about 50% may be achieved in 48 hours at ambient temperatures. Further, the highest achievable value for Sward hardness for the ambient cure samples may actually be higher in the ambient cure samples. It is believed that the slower cure may allow for a longer period of mobility of the reactive groups, allowing for more groups to react before the remaining groups are isolated by the increasing viscosity of the formulation.

A further study was performed to compare properties of experimental films with films made from commercial polyurethane resins (the control described in the procedures). The results for this study are presented in Tables 2-5. All of the films in this second study were cured at ambient temperature. The comparison of cure times is shown in Table 2. As can be seen from these results, the experimental systems cure faster at ambient temperatures than a commercial polyurethane system, being dry to the touch within about 3-9 minutes, as compared to about 17 minutes for the control film. Further, the experimental films are dried throughout the thickness within about 47 minutes, compared to about 120 minutes for the control film.

Further property comparisons between the experimental films of the present techniques and the commercial control, measured after aging the films for 7 days, are presented in Table 3. As can be seen from these results, adhesion to the substrate was not as good as the control films. However, other measured properties, including Sward hardness and impact resistance were better for the 100 mole % isocyanate runs (run 3) than for the control (run 4). Further, as shown in Table 4, results for the MEK Rub tests show that the experimental films are much more resistant to solvent than the control films. The 100 mole % isocyanate film is also more resistant to long term water immersion and has the highest wear resistance. The tensile strength for the 100 mole % isocyanate film is slightly lower that the control film.

The environmental degradation resistance of the experimental and control films is presented in Table 5. As can be seen from this data, the results for the 100 mole % isocyanate films are similar to those obtained for the control films.

While the techniques presented herein may be susceptible to various modifications and alternative forms, specific embodiments have been shown by way of example in the drawings and have been described in detail herein. However, it should be understood that the invention is not intended to be limited to the particular forms presented. Rather, the invention is to cover all modifications, equivalents and alternatives falling within the spirit and scope of the invention as defined by the following appended claims.

TABLE 1
Results for coatings made from MHSO and Desmodur N-75

| | | | | | Ambient | | | | | |
|---|---|---|---|---|---|---|---|---|---|---|
| | | | | | | | | | MEK | Impact |
| | Formulation | | | | Sward Hardness | | | | Rub | Resistance |
| | Isocyanate | Catalyst | Amine Level | Tin Level | Day 1 | Day 2 | Day 4 | Day 6 | Day 9 | Day 9 |
| 1 | 50% | Amine | 0.1 | 0 | 4 | 5 | 5 | 6 | | |
| 2 | 50% | Amine | 0.25 | 0 | 4 | 5 | 7 | 7 | | |
| 3 | 50% | Tin | 0 | 0.05 | 1 | 2 | 4 | 4 | | |
| 4 | 50% | Tin | 0 | 0.5 | 1 | 2 | 4 | 4 | | |
| 5 | 50% | Tin-Amine | 0.1 | 0.05 | 5 | 6 | 8 | 8 | 0 | 76 |
| 6 | 50% | Tin-Amine | 0.25 | 0.05 | 6 | 7 | 8 | 9 | 0 | 72 |
| 7 | 50% | Tin-Amine | 0.1 | 0.5 | 6 | 8 | 9 | 10 | 0 | 32 |
| 8 | 50% | Tin-Amine | 0.25 | 0.5 | 8 | 9 | 9 | 10 | 0 | 45 |
| 9 | 100% | Amine | 0.1 | 0 | 1 | 3 | 6 | 11 | | |
| 10 | 100% | Amine | 0.25 | 0 | 1 | 6 | 10 | 13 | | |
| 11 | 100% | Tin | 0 | 0.05 | 1 | 1 | 4 | 6 | | |
| 12 | 100% | Tin | 0 | 0.5 | 1 | 2 | 5 | 9 | | |
| 13 | 100% | Tin-Amine | 0.1 | 0.05 | 3 | 12 | 20 | 24 | 5 | 24 |
| 14 | 100% | Tin-Amine | 0.25 | 0.05 | 5 | 14 | 21 | 21 | 5 | 35 |
| 15 | 100% | Tin-Amine | 0.1 | 0.5 | 17 | 23 | 24 | 27 | 5 | 6 |
| 16 | 100% | Tin-Amine | 0.25 | 0.5 | 19 | 22 | 21 | 20 | 5 | 4 |

| | Baked at 130° C. for 3 hrs | | | | | | | |
|---|---|---|---|---|---|---|---|---|
| | | | | | MEK | Impact | | |
| | Sward Hardness | | | | Rub | Resistance | | |
| | Day 1 | Day 2 | Day 4 | Day 6 | Day 7 | Day 7 | Ambient | Oven |
| | | | | | | | MEK Resistance | |
| | | | | | | | (3 min exposure, 5 Drops Test) | |
| 1 | 9 | 9 | 9 | 10 | 4.0 | 71.0 | | |
| 2 | 9 | 10 | 10 | 10 | 4.5 | 71 | | |
| 3 | 9 | 9 | 9 | 9 | 4.0 | 69 | | |
| 4 | 8 | 10 | 8 | 10 | 4.0 | 67 | | |
| 5 | 8 | 9 | 9 | 9 | 4.0 | 73 | Heavy film lifting | NC*-fingernail |
| | | | | | | | and swelling | scratch-soft |
| 6 | 9 | 9 | 9 | 10 | 4.9 | 69 | Heavy film lifting | NC-fingernail |
| | | | | | | | and swelling | scratch-soft |
| 7 | 8 | 8 | 9 | 8 | 4.0 | 59 | Severe film lifting | Heavy film lifting |
| | | | | | | | and swelling | and swelling |
| 8 | 9 | 9 | 9 | 8 | 4.0 | 53 | Severe film lifting | Heavy film lifting |
| | | | | | | | and swelling | and swelling |
| | | | | | | | MEK Resistance | |
| | | | | | | | (10 min exposure, 5 Drops Test) | |
| 9 | 22 | 21 | 22 | 22 | 5.0 | 35 | | |
| 10 | 15 | 18 | 20 | 20 | 5.0 | 49 | | |
| 11 | 21 | 24 | 25 | 22 | 5.0 | 33 | | |
| 12 | 27 | 26 | 27 | 26 | 5.0 | 48 | | |
| 13 | 19 | 23 | 22 | 26 | 5.0 | 33 | NC-fingernail scratch- | NC |
| | | | | | | | slightly soft film | |
| 14 | 13 | 17 | 16 | 17 | 5.0 | 36 | NC-fingernail scratch- | NC-fingernail scratch- |
| | | | | | | | slightly soft film | slightly soft film |
| 15 | 22 | 18 | 23 | 22 | 5.0 | 17 | NC-fingernail scratch- | NC |
| | | | | | | | slightly soft film | |
| 16 | 15 | 13 | 16 | 16 | 5.0 | 12 | NC-fingernail scratch- | NC |
| | | | | | | | slightly soft film | |

*NC—“No Change” - No film lifting or swelling

TABLE 2
Comparison of MHSO/Desmodur N-75 films with commercial control.

| | | | | | Initial | | | |
|---|---|---|---|---|---|---|---|---|
| | | Wet Applied, Ambient | | | Dry | | Initial | |
| | | Application | | | Film | | Gloss (avg) | |
| | Mixed Catalyst, | Dry to | | Dry | Thickness | | | Alum |
| | Ambient Cure | Touch, | Dry Hard, | Through, | CRS | Alum | CRS | 20/ |
| Sample | Isocyanate % | CRS, min | CRS, min. | CRS, min. | (mils) | (mils) | 20/60 | 60 |
| 1 | 50% | 3:30 | 12:45 | 24:30 | 2.21 | 1.77 | 62/117 | 88/127 |
| 2 | 75% | 6:00 | 14:00 | 22:30 | 2.24 | 1.63 | 64/116 | 98/130 |
| 3 | 100% | 9:00 | 23:00 | 47:00 | 2.24 | 1.99 | 72/118 | 104/132 |
| 4 | Control | 17:00 | 120:00 | 120:00 | 2.02 | 1.79 | 106/120 | 125/133 |

TABLE 3
Properties of films aged at ambient temperature for 7 days before testing.

| | | | | | | | | | | Flexibility | | | | |
|---|---|---|---|---|---|---|---|---|---|---|---|---|---|---|
| | | Crosscut Adhesion | | | | Hardness | | | | Conical | Impact Resistance (in-lbs) | | | |
| | Mixed Catalyst, | CRS | CRS | | | Sward | | | | Mandrel | Direct | Direct | Reverse | Reverse |
| | Ambient Cure | 7 | 20 | Alum | Alum | 7 | Sward | Pencil | Pencil | Alum | Impact | Impact | Impact | Impact |
| Sample | Isocyanate % | Day | Day | 7 Day | 20 Day | Day | 20 Day | 7 Day | 20 Day | 7 Day | 7 Day | 20 Day | 7 Day | 20 Day |
| 1 | 50% | 0 | 0 | 0 | 0 | 9 | 9 | F | F | Pass ⅛″ | 74 | 72 | 80 | 75 |
| 2 | 75% | 0 | 0 | 0 | 0 | 17 | 20 | H | H | Pass ⅛″ | 54 | 50 | 44 | 50 |
| 3 | 100% | 0 | 0 | 0 | 0 | 25 | 27 | 2H | 2H | Pass ⅛″ | 35 | 26 | 18 | 38 |
| 4 | Control | 3 | 4 | 0 | 0 | 19 | 21 | H | H | Pass ⅛″ | 10 | 8 | 6 | 6 |

5 - Excellent adhesion
0 - Poor adhesion
Number of rocks

TABLE 4
Properties of films aged at ambient temperatures for 7 days prior to testing

| | | Abrasion, Solvent, Water and Heat Resistance | | | | | | | Free Film Properties | |
|---|---|---|---|---|---|---|---|---|---|---|
| | | Solvent | | | Water | | | | (Films aged 17 Days) | |
| | Mixed Catalyst, | MEK | | | 24 Hour | 7 Day | Heat 24 Hour | Abrasion | Tensile | |
| | Ambient Cure | Rubs | MEK | MEK | Water | Water | Resistance | Taber Alum | Strength | |
| Sample | Isocyanate % | 50 | Rubs 100 | Drop | Immersion | Immersion | (250 F.) | (Wear Index) | (psi) | Elongation (%) |
| 1 | 50% | 4.9 Soft | 0 Soft | Lift 2:53 | Slt Softening | Soft above | NC | 0.256 | 1,482 | 46 |
| | | | | | of Film | and below | | | | |
| | | | | | | water | | | | |
| 2 | 75% | 4.9 Mod | 4 Slt Soft | Lift > 5:00 | Slt Softening | Soft below | NC | 0.084 | 1,866 | 15 |
| | | | | | of Film | water | | | | |
| 3 | 100% | 5 Hard | 5 Hard | Slt soft | Slt Softening | Slt delam | NC | 0.048 | 2,469 | 4 |
| | | | | | of Film | below | | | | |
| | | | | | | water | | | | |
| 4 | Control | 0 Soft | 0 Soft | Lift 1:33 | Slt Softening | Slt delam | NC | 0.124 | 2,715 | 6 |
| | | | | | of Film | &soft | | | | |
| | | | | | | below | | | | |
| | | | | | | water | | | | |

5 - No effect on surface
0 - Penetration to the substrate
Lower #, Less Wear

TABLE 5
Properties of films aged at ambient temperatures for 14 days prior to testing

| | | 7 Day Salt Spray Exposure | | | | | | | | | |
|---|---|---|---|---|---|---|---|---|---|---|---|
| | | | | | X | | | | | | |
| | Mixed Catalyst, | Non Scribed | Non Scribed | Non | Scribe | X Scribe | | QUV Exposure | | | |
| | Ambient Cure | Initial | Rust | Scribed | Growth | Rust | X Scribe | 8 | | | Humidity |
| Sample | Isocyanate % | Rust | Rating % | Blisters | from X | Rating % | Blisters | Hour | 24 Hour | 168 Hour | 7 Day |
| 1 | 50% | 4 Hours | 7 | 4 | 5 mm | 6 | 4 | V. Low | Med | Med | NC |
| | | | 0.3% | Med | | 1% | Med D | Yellow 1 | Yellow 4 | Yellow 4 | |
| 2 | 75% | 8 Hours | 6 | 8 | 6 mm | 5 | 4 | V. Low | Low-Med | Med | NC |
| | | | 1% | Few | | 3% | Med D | Yellow 1 | Yellow 3 | Yellow 4 | |
| 3 | 100% | 24 hours | 5 | 6 | 5 mm | 7 | 4 | V. Low | Low | Med-High | NC |
| | | | 3% | Med | | 0.30% | Med | Yellow 1 | Yellow 2 | Yellow 5 | |
| 4 | Control | 48 Hours | 4 | 8 | 5 mm | 4 | 4 | Low | Low | High | NC |
| | | | 10% | Few | | 10% | Med D | Yellow 2 | Yellow 2 | Yellow 6 | |

Rust Rating Scale 1-9 (Heavy-No Rust)
% Area Rusted (50% to 0.03%)
Blister Size: 2-8 (Large-Small) [symbol]
Rating
6 = High Yellow
0 = No Yellowing [symbol]
indicates data missing or illegible when filed

What is claimed is:

1. A formulation for a coating or adhesive, comprising:
a first part comprising active molecules having an average of at least one thiol group per active molecule and an average of at least one hydroxyl group per active molecule;
a second part comprising monomer molecules having an average of at least two isocyanate groups per monomer molecule; and
a catalyst composition comprising an amine catalyst and a metal catalyst, wherein the catalyst composition will cure a mixture of the first part and the second part to greater than about 50% of full strength at ambient temperature in less than about 48 hours.

2. The formulation of claim 1, wherein ambient temperature is greater than about 20° C. and less than about 30° C.

3. The formulation of claim 1, wherein the mixture cures to a strength after about 48 hours at ambient temperature that is within about 90% of a strength obtained if the mixture was baked at about 130° C. for about 3 hours.

4. The formulation of claim 1, wherein the mixture cures within about 48 hours at ambient temperature to a strength substantially equal to a strength of a similar mixture cured with only one of the amine or the metal catalyst after about 144 hours at ambient temperature.

5. The formulation of claim 1, wherein the catalyst composition is included with the first part, is included with the second part, or is provided as a third part, or any combination thereof.

6. The formulation of claim 1, wherein the active molecules comprise an unsaturated ester that has been reacted to form a mercaptanized unsaturated ester, a mercaptanized epoxidized unsaturated ester, a crosslinked mercaptanized unsaturated ester, or a hydroxy thiol ester, or any combination thereof.

7. The formulation of claim 6, wherein the unsaturated ester comprises a tallow oil, an olive oil, a peanut oil, a castor bean oil, a sunflower oil, a sesame oil, a poppy seed oil, a palm oil, an almond seed oil, a hazelnut oil, a rapeseed oil, a canola oil, a soybean oil, a corn oil, a safflower oil, a cottonseed oil, a camelina oil, a flaxseed oil, or a walnut oil, or any combination thereof.

8. The formulation of claim 6, wherein the unsaturated ester comprises a synthetic unsaturated ester.

9. The formulation of claim 1, wherein the monomer molecules comprise an aliphatic isocyanate having an average of at least two isocyanate groups per molecule, a cycloaliphatic isocyanate having an average of at least two isocyanate groups per molecule, or an aromatic isocyanate having an average of at least two isocyanate groups per molecule, or any combination thereof.

10. The formulation of claim 1, wherein the metal catalyst comprises a zinc catalyst, tin catalyst, a bismuth catalyst, or an iron catalyst, or any combination thereof.

11. The formulation of claim 1, wherein the first part, the second part, or the catalyst composition, or any combination thereof, comprises a solvent.

12. The formulation of claim 11, wherein the solvent comprises methyl ethyl ketone, glycerol carbonate, acetone, hexene, petroleum distillate, butyl acetate, toluene, or benzene, or any combination thereof.

13. The formulation of claim 1, wherein the first part, the catalyst composition, or both, comprises a property modifying agent.

14. The formulation of claim 13, wherein the property modifying agent comprises a polyol, an elastic diol comonomer, or a propylene glycol, or any combination thereof.

15. The formulation of claim 1, wherein the strength is measured by Sward hardness, impact resistance, MEK rub, or adhesive strength, or a combination thereof.

16. A thiourethane composition comprising a contact product of contact elements comprising:
a reactive composition containing active molecules having an average of at least one thiol group per active molecule and an average of at least one hydroxyl group per active molecule;
a monomer composition comprising monomer molecules having an average of at least two isocyanate groups per monomer molecule;
an amine catalyst; and
a metal catalyst;
wherein the thiourethane composition cures to greater than about 50% of full strength within about 48 hours at ambient temperature.

17. The thiourethane composition of claim 16, wherein ambient temperature is greater than about 20° C. and less than about 30° C.

18. The thiourethane composition of claim 16, wherein the contact product cures to a strength after 48 hours at ambient temperature that is within about 90% of a strength obtained if the contact product was baked at about 130° C. for about 3 hours.

19. The thiourethane composition of claim 16, wherein the contact product cures within about 48 hours at ambient temperature to a strength substantially equal to a strength of a similar contact product cured with only one of the amine or the metal catalyst after about 144 hours at ambient temperature.

20. The thiourethane composition of claim 16, wherein the active molecules comprise an unsaturated ester that has been reacted to form a mercaptanized unsaturated ester, a mercaptanized epoxidized unsaturated ester, a crosslinked mercaptanized unsaturated ester, or a hydroxyl thiol ester, or any combination thereof.

21. The thiourethane composition of claim 20, wherein the unsaturated ester comprises a tallow oil, an olive oil, a peanut oil, a castor bean oil, a sunflower oil, a sesame oil, a poppy seed oil, a palm oil, an almond seed oil, a hazelnut oil, a rapeseed oil, a canola oil, a soybean oil, a corn oil, a safflower oil, a cottonseed oil, a camelina oil, a flaxseed oil, or a walnut oil, or any combination thereof.

22. The thiourethane composition of claim 20, wherein the unsaturated ester comprises a synthetic unsaturated ester.

23. The thiourethane composition of claim 16, wherein the monomer molecules comprise an aliphatic isocyanate having an average of at least two isocyanate groups per molecule, a cycloaliphatic isocyanate having an average of at least two isocyanate groups per molecule, or an aromatic isocyanate having an average of at least two isocyanate groups per molecule, or any combination thereof.

24. The thiourethane composition of claim 16, wherein the metal catalyst comprises a zinc catalyst, tin catalyst, a bismuth catalyst, or an iron catalyst, or any combination thereof.

25. The thiourethane composition of claim 16, wherein the strength is measured by Sward hardness, impact resistance, MEK rub, or adhesive strength, or a combination thereof.

26. A method, comprising:
forming a composition comprising a contact product of contact elements comprising:
a reactive composition comprising active molecules having an average of at least one thiol group per active molecule and an average of at least one hydroxyl group per active molecule;
a monomer composition comprising monomer molecules having an average of at least two isocyanate groups per monomer molecule; and
a catalyst composition comprising a metal catalyst and an amine catalyst;
applying the contact product to at least a portion of a surface of an item; and
allowing the contact product to cure at ambient temperature, wherein the contact product cures to greater than about 50% of full strength within about 48 hours.

27. The method of claim 26, wherein ambient temperature is greater than about 20° C. and less than about 30° C.

28. The method of claim 26, comprising allowing the contact product to cure for 48 hours at ambient temperature, wherein the contact product obtains a strength that is at least about 95% of a strength obtained if the contact product was baked at about 130° C. for about 3 hours.

29. The method of claim 26, wherein the contact product obtains a strength within about 48 hours at ambient temperature that is substantially equal to the strength of a similar contact product containing only one of the amine or the metal catalyst after about 144 hours at ambient temperature.

30. The method of claim 26, wherein the active molecules comprise an unsaturated ester that has been reacted to form a mercaptanized unsaturated ester, a mercaptanized epoxidized unsaturated ester, a crosslinked mercaptanized unsaturated ester, or a hydroxyl thiol ester, or any combination thereof.

31. The method of claim 30, wherein the unsaturated ester comprises a tallow oil, an olive oil, a peanut oil, a castor bean oil, a sunflower oil, a sesame oil, a poppy seed oil, a palm oil, an almond seed oil, a hazelnut oil, a rapeseed oil, a canola oil, a soybean oil, a corn oil, a safflower oil, a cottonseed oil, a camelina oil, a flaxseed oil, or a walnut oil, or any combination thereof.

32. The method of claim 30, wherein the unsaturated ester comprises a synthetic unsaturated ester.

33. The method of claim 26, wherein the monomer molecules comprise an aliphatic isocyanate having an average of at least two isocyanate groups per molecule, a cycloaliphatic isocyanate having an average of at least two isocyanate groups per molecule, or an aromatic isocyanate having an average of at least two isocyanate groups per molecule, or any combination thereof.

34. The method of claim 26, wherein the strength is measured by Sward hardness, impact resistance, MEK rub, or adhesive strength, or a combination thereof.

35. A coated item, comprising:
an object having at least a portion that has a coating comprising a contact product of contact elements comprising:
a composition comprising active molecules having an average of at least one thiol group per active molecule and an average of at least one hydroxyl group per active molecule;
a monomer composition comprising monomer molecules having an average of at least two isocyanate groups per monomer molecule; and
a catalyst composition comprising at least one metal catalyst and at least one amine catalyst;
wherein the coating cures at ambient temperature to greater than about 50% of full strength with about 48 hours.

36. The method of claim 35, wherein the coating cures to a strength after about 48 hours at ambient temperature that is within about 95% of a strength obtained if the coating was baked at about 130° C. for about 3 hours.

37. The coating of claim 35, wherein the coating cures within about 48 hours at ambient temperature to a strength substantially equal to a strength of a similar coating cured with only one of the amine or the metal catalyst after about 144 hours at ambient temperature.

38. The coating of claim 35, wherein the strength is measured by Sward hardness, impact resistance, MEK rub, or adhesive strength, or a combination thereof.
